(19) United States
(12) Patent Application Publication
(10) Pub. No.: US 2003/0209111 A1
(43) Pub. Date: Nov. 13, 2003

(54) Wrench

(76) Inventor: Hsiu-Ching Huang, Taipei (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/360,175

(22) Filed: Feb. 7, 2003

Related U.S. Application Data
(63) Continuation-in-part of application No. 10/144,895, filed on May 13, 2002.

(51) Int. Cl. B25B 13/02

(52) U.S. Cl. 81/119

(57) ABSTRACT

A wrench includes a head and a handle. The head includes a first jaw formed thereon, a second jaw formed thereon and a throat formed between the first and second jaws. The first jaw includes a first number of teeth. The second jaw includes a second number of teeth. The first number is greater than the second number. The handle extends from the head. The teeth of the first jaw are smaller than that of the second jaw.

### CROSS REFERENCE

This patent application is a continuation-in-part application of U.S. patent application Ser. No. 10/144,895 filed on May 13, 2002.

### BACKGROUND OF INVENTION

1. Field of Invention

The present invention relates to a wrench.

2. Related Prior Art

Referring to FIG. 3, a conventional wrench 10 includes a head (not numbered), a handle 11 extending from the head in a direction, and two jaws 12 and 13 extending from the head in an opposite direction. The jaw 12 includes a flat surface 121. The jaw 13 includes a flat surface 131. A throat 14 is formed between the jaws 12 and 13. The throat 14 includes an arched surface (not numbered). In use, the head of the wrench 10 is engaged with a head of a bolt 20. The flat surfaces 121 and 131 contact two facets 21 and 22 of the head of the bolt 20, respectively. Two problems are encountered in use of the wrench 10. Firstly, slipping happens between the flat surface 121 and the facet 21 and between the flat surface 131 and the facet 22. Secondly, a corner 23 may be worn out by the arched surface of the throat 14, and corners 24 and 25 by the flat surfaces 121 and 131, respectively.

Referring to FIG. 4, another conventional wrench 30 is devised to eliminate the first problem encountered in use of the wrench 10. The wrench 30 includes a head (not numbered), a handle 31 extending from the head in a direction, and two jaws 32 and 33 extending from the head in an opposite direction. The jaw 32 includes a serrate surface 321. The jaw 33 includes a serrate surface 331. A throat 34 is formed between the jaws 32 and 33. The throat 34 includes an arched surface (not numbered). In use, the head of the wrench 30 is engaged with a head of a bolt 20. The serrate surfaces 321 and 331 contact facets 21 and 22 of the head of the bolt 20, respectively, thus preventing slipping between the serrate surface 321 and the facet 21 and between the serrate surface 331 and the facet 22. However, a corner 23 may be worn out by the arched surface of the throat 34, and corners 24 and 25 by the serrate surfaces 321 and 331, respectively.

The present invention is therefore intended to obviate or at least alleviate the problems encountered in prior art.

### SUMMARY OF INVENTION

It is an objective of the present invention to provide a wrench for firm engagement with a head of a bolt in use.

It is another objective of the present invention to provide a wrench that protects a head of a bolt in use.

According to the present invention, a wrench includes a head and a handle. The head includes a first jaw formed thereon, a second jaw formed thereon and a throat formed between the first and second jaws. The first jaw includes a first number of teeth. The second jaw includes a second number of teeth. The first number is greater than the second number. The handle extends from the head. The teeth of the first jaw are smaller than that of the second jaw.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a planar view of a wrench according to the present invention;

FIG. 2 is a planar view of the wrench shown in FIG. 1 in engagement with a head of a bolt;

FIG. 3 is a planar view of a conventional wrench engaged with a head of a bolt; and

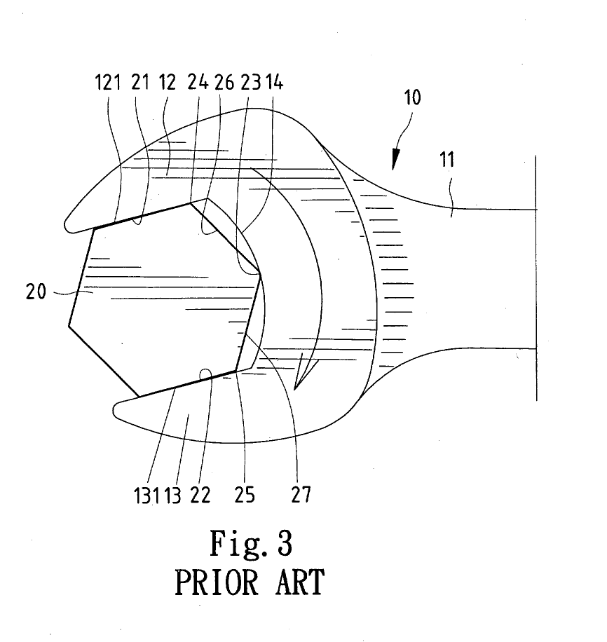

FIG. 4 is a planar view of another conventional wrench in engagement with a head of a bolt.

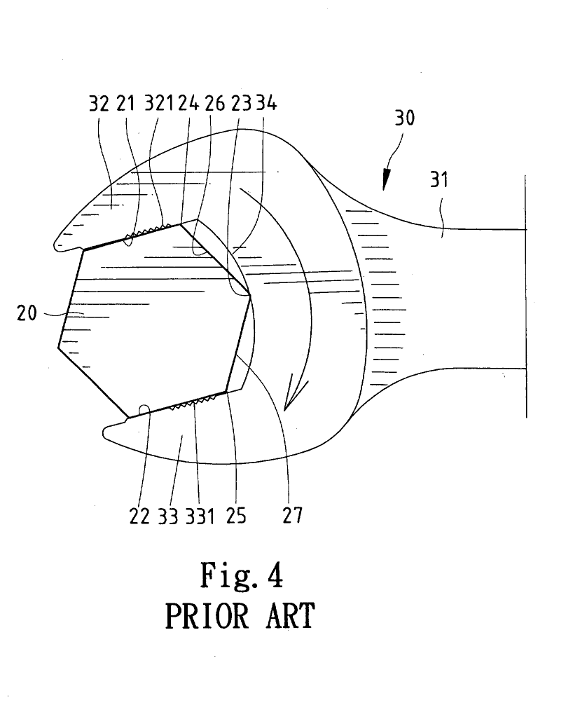

### DETAILED DESCRIPTION OF PREFERRED EMBODIMENT

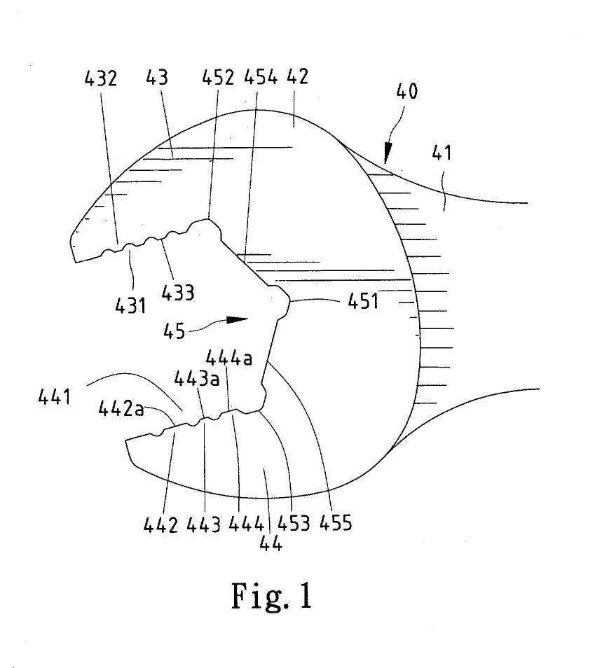

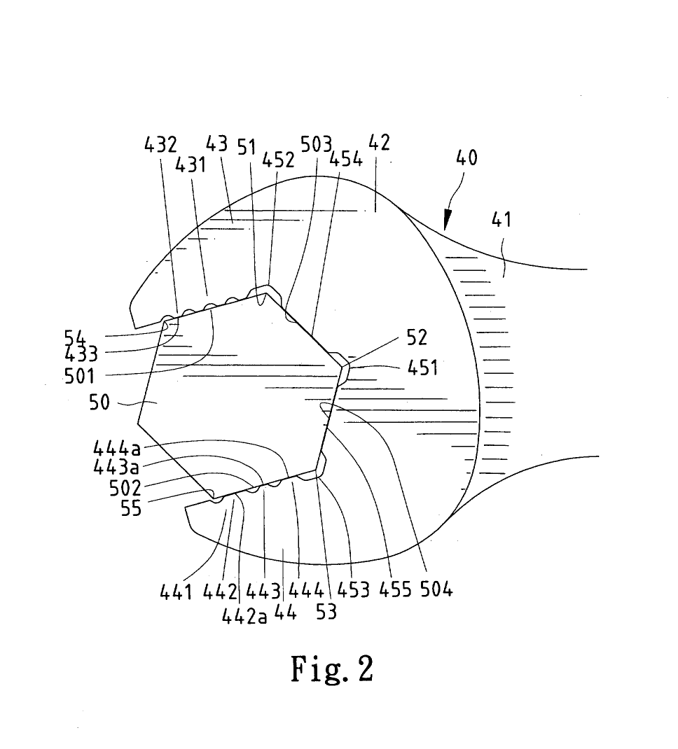

Referring to FIGS. 1 and 2, a wrench 40 according to the preferred embodiment of the present invention includes a head 42, a handle 41 extending from the head 42 in a direction and two jaws 43 and 44 extending from the head 42 in an opposite direction.

A throat 45 is formed between the jaws 43 and 44.

The jaw 43 includes a serrated surface 431 consisting of four teeth 432 each including a crown 433.

Similarly, the jaw 44 includes a serrated surface 441 consisting of a first tooth 442, a second tooth 443 and a third tooth 444. The first tooth 442 includes a crown 442a. The second tooth 443 includes a crown 443a. The third tooth 444 includes a crown 444a. The crown 442a of the first tooth 442 is longer than the crown 444a of the third tooth 444. The crown 444a of the third tooth 444 is longer than the crown 443a of the second tooth 443. The crown 443a of the second tooth 443 is longer than the crown 433 of each tooth 432.

The throat 45 includes two flat surfaces 454 and 455 corresponding to two adjacent facets of a head of a bolt. The throat 45 defines a recess 451 between the flat surfaces 454 and 455, a recess 452 between the serrate surface 431 and the flat surface 454 and a recess 453 between the serrate surface 441 and the flat surface 455.

FIG. 2 shows a head 50 of a bolt (not shown). The head 50 of the bolt includes two parallel facets 501 and 502 and two adjacent facets 503 and 504 between the facets 501 and 520. The head 50 of the bolt includes a corner 51 formed between the facets 501 and 503, a corner 52 between the facets 503 and 504 and a corner 53 between the facets 504 and 502.

The head 42 of the wrench 40 can engage with the head 50 of the bolt. The serrate surface 431 engages with the facet 501, the serrate face 441 with the facet 502, the flat surface 454 with the facet 503, and the flat surface 455 with the facet 504. The corner 51 is positioned in the recess 452, the corner 52 in the recess 451 and the corner 53 in the recess 453.

Thus, slipping between the serrate surface 431 and the facet 501 and between the serrate face 441 and the facet 502 is avoided. The wearing out of the corners 51, 52 and 53 is avoided.

The wrench 40 is often pivoted in an angular direction from the jaw 43 to the jaw 44 through the throat 45. Hence, the teeth 432 are subject to a smaller force than the teeth 442, 443 and 444 are. The teeth 432 are made smaller than the teeth 442, 443 and 444, i.e., the crowns 433 are smaller than the crowns 442a, 443a and 444a. The jaw 43 is at a first angle from the handle 41. The jaw 44 is at a second angle from the handle 41. The first angle is greater than the second angle.

Furthermore, the flat surface 454 engages with the facet 503, and the flat surface 455 with the facet 504. Thus, the wrench 40 can exert a greater torque on a head of a bolt than a conventional wrench can.

The present invention has been described via illustration of the preferred embodiment. Those skilled in the art can derive variations from the preferred embodiment without departing from the scope of the present invention. Hence, the preferred embodiment shall not limit the scope of the present invention defined in the attached claims.

What is claimed is:

1. A wrench including:
a head including a first jaw formed thereon and with a first number of teeth, a second jaw formed thereon and with a second number of teeth and a throat formed between the first and second jaws wherein the first number is greater than the second number; and
a handle extending from the head.

2. The wrench according to claim 1 wherein the teeth of the first jaw are smaller than that of the second jaw.

3. The wrench according to claim 1 wherein the first jaw includes four teeth, and the second jaw includes three teeth.

4. The wrench according to claim 3 wherein the second jaw includes first, second and third teeth, the first tooth of the second jaw is larger than the third tooth of the second jaw, the third tooth of the second jaw is larger than the second tooth of the second jaw.

5. The wrench according to claim 1 wherein the wrench is a directional wrench that is often pivoted in an angular direction from the first jaw through the throat to the second jaw.

6. The wrench according to claim 1 wherein the first jaw is at a first angle from the handle, and the second jaw is at a second angle from the handle, and the first angle is greater than the second angle.

7. The wrench according to claim 1 wherein the throat defines a central recess.

8. The wrench according to claim 1 wherein the throat includes two contact surfaces between which the central recess is defined.

9. The wrench according to claim 1 wherein the head defines a recess between the throat and the first jaw.

10. The wrench according to claim 1 wherein the head defines a recess between the throat and the second jaw.

11. A wrench including:
a head including a first jaw formed thereon and with a plurality of teeth and a second jaw formed thereon and with a plurality of teeth wherein the teeth of the first jaw are smaller than that of the second jaw; and
a handle extending from the head in an opposite direction.

12. The wrench according to claim 11 wherein the first jaw includes a first number of teeth, and the second jaw includes a second number of teeth, and the first number is greater than the second number.

13. The wrench according to claim 12 wherein the first jaw includes four teeth, and the second jaw includes three teeth.

14. The wrench according to claim 13 wherein the second jaw includes first, second and third teeth, the first tooth of the second jaw is larger than the third tooth of the second jaw, the third tooth of the second jaw is larger than the second tooth of the second jaw.

15. The wrench according to claim 11 wherein the wrench is a directional wrench that is often pivoted in an angular direction from the first jaw through the throat to the second jaw.

16. The wrench according to claim 11 wherein the first jaw is at a first angle from the handle, and the second jaw is at a second angle from the handle, and the first angle is greater than the second angle.

17. The wrench according to claim 11 wherein the throat defines a central recess.

18. The wrench according to claim 11 wherein the throat includes two contact surfaces between which the central recess is defined.

19. The wrench according to claim 11 wherein the head defines a recess between the throat and the first jaw.

20. The wrench according to claim 11 wherein the head defines a recess between the throat and the second jaw.
